(19) United States
(12) Patent Application Publication
(10) Pub. No.: US 2022/0012831 A1
(43) Pub. Date: Jan. 13, 2022

(54) SYSTEM AND METHOD FOR ANALYZING COLLABORATIVE ENVIRONMENTS TO IDENTIFY PROBABILITY OF INVENTION

(71) Applicant: STATE FARM MUTUAL AUTOMOBILE INSURANCE COMPANY, Bloomington, IL (US)

(72) Inventors: Brian Nathan Bellville, Urbana, IL (US); Patrick J. Johnson, Champaign, IL (US); Amy Radue Engelhorn, Normal, IL (US)

(21) Appl. No.: 15/839,776

(22) Filed: Dec. 12, 2017

(51) Int. Cl. G06Q 50/18; G06Q 10/06; G06Q 10/10

(52) U.S. Cl. CPC G06Q 50/184; G06Q 10/101; G06Q 10/06398

(57) ABSTRACT

Systems and methods for estimating the likelihood that an individual or project in a collaborative environment will produce intellectual property are provided. A plurality of relationships that exist between individuals in a collaborative environment may be identified and mapped by one or more processors. In particular, the individuals in the collaborative environment who have historically produced intellectual property may be indicated within the context of the map. Based on a particular individual's mapped relationships to one or more other individuals in the collaborative environment who have historically produced intellectual property, a probability that the particular individual will produce intellectual property may be calculated. Additionally, one or more projects (e.g., including individuals having relationships with one another) may be identified within the context of the map. Based on the individuals in a project who have historically produced intellectual property, a probability that the project will produce intellectual property may be calculated.

### FIELD OF DISCLOSURE

In general, the present application is related to intellectual property, such as, e.g., patentable inventions. In particular, the present application is related to systems and methods for estimating the likelihood that an individual and/or project in a collaborative environment will produce intellectual property.

### BACKGROUND

Individuals within collaborative work environments, such as, e.g., laboratories, universities, businesses, etc., may often develop innovative ideas within project teams. In many instances, these ideas may mature into intellectual property (e.g., patentable subject matter). However, identifying intellectual property produced in a collaborative work environment can be an overwhelming task for stakeholders when there are a large number of individuals and/or project teams in the collaborative work environment. As a result, some of the intellectual property produced within the collaborative work environment may never be captured, or may not be captured in time to file a patent application, e.g., before a public disclosure or other bar date.

### SUMMARY

In one aspect, a computer-implemented method for estimating the likelihood that an individual in a collaborative environment will produce intellectual property is provided. The computer-implemented method may include steps of identifying, by one or more processors, a plurality of relationships that exist between individuals in a collaborative environment; mapping, by the one or more processors, the plurality of relationships that exist between the individuals in the collaborative environment; indicating, by the one or more processors, within the mapped relationships, the individuals in the collaborative environment who have historically produced intellectual property; and calculating, by the one or more processors, based on a particular individual's mapped relationships to one or more other individuals in the collaborative environment who have historically produced intellectual property, a probability that the particular individual will produce intellectual property.

In another aspect, a computer-implemented method for estimating the likelihood that a project in a collaborative environment will produce intellectual property is provided. The computer-implemented method may include steps of identifying, by one or more processors, a plurality of relationships that exist between individuals in a collaborative environment; mapping, by the one or more processors, the plurality of relationships that exist between the individuals in the collaborative environment to identify one or more projects, wherein each project comprises two or more individuals, each individual in the project having a relationship to each other individual in the project; indicating, by the one or more processors, within the mapped relationships, the individuals in the collaborative environment who have historically produced intellectual property; and calculating, by the one or more processors, based on the individuals in a project who have historically produced intellectual property, a probability that the project will produce intellectual property.

In still another aspect, a computer system configured to estimate the likelihood that an individual in a collaborative environment will produce intellectual property is provided. The computer system may include a database configured to store information associated with individuals in a collaborative environment; a memory configured to store non-transitory computer executable instructions; and a processor configured to interface with the memory and the database. In particular, the processor may be configured to execute the non-transitory computer executable instructions to cause the processor to identify a plurality of relationships that exist between the individuals in the collaborative environment; map the plurality of relationships that exist between the individuals in the collaborative environment; indicate, within the mapped relationships, the individuals in the collaborative environment who have historically produced intellectual property; and calculate, based on a particular individual's mapped relationships to one or more other individuals in the collaborative environment who have historically produced intellectual property, a probability that the particular individual will produce intellectual property.

In an additional aspect, a computer system configured to estimate the likelihood that a project in a collaborative environment will produce intellectual property is provided. The computer system may include a database configured to store information associated with individuals in a collaborative environment; a memory configured to store non-transitory computer executable instructions; and a processor configured to interface with the memory and the database. In particular, the processor may be configured to execute the non-transitory computer executable instructions to cause the processor to identify a plurality of relationships that exist between individuals in a collaborative environment; map the plurality of relationships that exist between the individuals in the collaborative environment to identify one or more projects, wherein each project comprises two or more individuals, each individual in the project having a relationship to each other individual in the project; indicate, within the mapped relationships, the individuals in the collaborative environment who have historically produced intellectual property; and calculate, based on the individuals in a project who have historically produced intellectual property, a probability that the project will produce intellectual property.

### BRIEF DESCRIPTION OF THE DRAWINGS

FIG. 1 illustrates an exemplary computer system for estimating the likelihood that an individual and/or project in a collaborative environment will produce intellectual property.

FIG. 2 illustrates an exemplary mapping of relationships between a group of individuals in a collaborative environment.

FIG. 3A illustrates a flow diagram of an exemplary computer-implemented method for estimating the likelihood that an individual in a collaborative environment will produce intellectual property.

FIG. 3B illustrates a flow diagram of an exemplary computer-implemented method for estimating the likelihood that a project in a collaborative environment will produce intellectual property.

### DETAILED DESCRIPTION

As discussed above, individuals within a collaborative work environment, such as, e.g., a lab, a university, a business, etc., may often collaborate to develop innovative ideas in project teams. In many instances, these ideas may mature into patentable subject matter. However, identifying patentable subject matter produced in the collaborative work environment may be an overwhelming task for stakeholders. As a result, some of the intellectual property produced within the collaborative work environment may not be captured in time to file a patent application, e.g., before a public disclosure or other bar date.

The present application addresses this known problem in the art by providing a means to predict the individuals and/or projects within the collaborative work environment that are most likely to produce intellectual property. That is, the present embodiments may relate to, inter alia, technology for estimating the likelihood that an individual and/or a project in a collaborative environment will produce (or has already produced) intellectual property. The likelihood that a given individual and/or a given project will produce (or has already produced) intellectual property may be related to both individual metrics (e.g., the number of previous inventions an individual has historically produced, the individual's connections to other inventors, etc.) as well as project metrics (e.g., the field of the project, the proportion of influential and/or prolific inventors collaborating on the project, etc.). By analyzing the relationships of a collaborative environment in light of these individual metrics and project metrics, the probability that an individual or a project will be likely to produce (or has already produced) intellectual property may be predicted. Accordingly, opportunities to disclose intellectual property may be provided to those individuals or projects most likely to produce intellectual property. In this way, more of the intellectual property that is created by individuals and/or projects in the collaborative environment may be captured and utilized by stakeholders. Additionally, hypothetical relationships or projects (i.e., “projects” comprising individuals that do not have collaborative relationships with one another) that may potentially be fruitful for developing intellectual property in the future may be identified. That is, individuals that do not currently work together may be likely produce intellectual property if they collaborate on a project. Accordingly, the individuals may be prompted to connect with other individuals with whom they may be likely to produce intellectual property in the future.

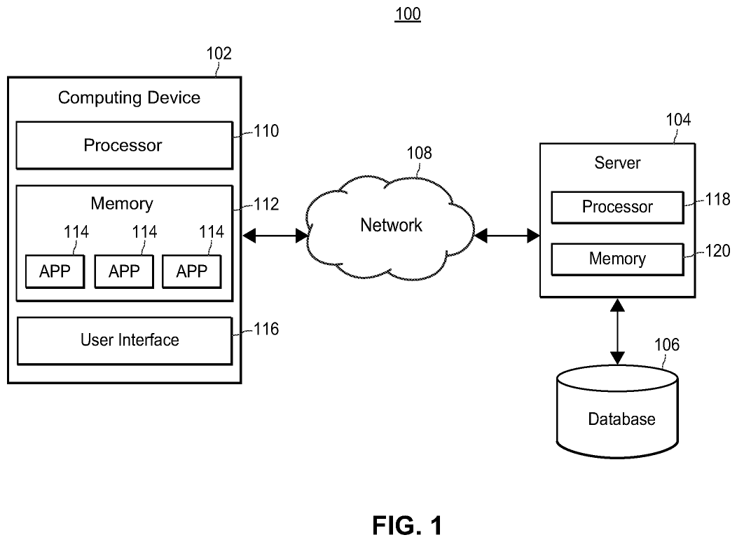

FIG. 1 illustrates an exemplary computer system 100 for estimating the likelihood that an individual and/or project in a collaborative environment will produce (or has already produced) intellectual property. The high-level architecture illustrated in FIG. 1 may include both hardware and software applications, as well as various data communications channels for communicating data between the various hardware and software components, as is described below. The system 100 may include a computing device 102, a server 104, and a database 106, which may communicate using one or more network 108, which may be a wireless network, or which may include a combination of wireless and wired networks.

The computing device 102 may in some instances be a collection of multiple co-located or geographically distributed computing devices, etc., and may include a processor 110 and a memory 112. The processor 110 may in some embodiments include multiple processors, and may be configured to execute any of the various software applications 114 residing on the memory 112. Moreover, the memory 112 may include multiple memories, which may be implemented as semiconductor memories, magnetically readable memories, optically readable memories, biologically readable memories, and/or any other suitable type(s) of non-transitory, computer-readable storage media. Additionally, the computing device 102 may include a user interface 116 (e.g., a display configured to display a user interface).

Similarly, the server 104 may in some instances be a collection of multiple co-located or geographically distributed servers, etc., and may include a processor 118 and a memory 120. The processor 118 may in some embodiments include multiple processors, and may be configured to execute software applications (not shown) residing on the memory 120. Moreover, the memory 120 may include multiple memories, which may be implemented as semiconductor memories, magnetically readable memories, optically readable memories, biologically readable memories, and/or any other suitable type(s) of non-transitory, computer-readable storage media.

The database 106 may store data related to, inter alia, individuals in a collaborative environment, their relationships, and/or their historical production of intellectual property, etc. In some instances, the database 106 may additional store data related to individuals in other collaborative environments, relationships between collaborative environments, etc. Accordingly, the computing device 102 and/or the server 104 may access the database 106 via the network 108, and the data stored by the database 106 may be used in the one or more applications 114 or in any applications of the memory 120.

The application(s) 114 may include multiple applications and/or may include multiple modules within one or more applications, e.g., an identifier application (or module) configured to identify a plurality of relationships that exist between individuals in a collaborative environment (and/or between collaborative environments); a mapping application (or module) configured to map the plurality of relationships that exist between the individuals in the collaborative environment; an application (or module) configured to indicate the individuals in the collaborative environment who have historically produced intellectual property within the context of the mapped relationships; and/or an application (or module) configured to calculate the probability that a particular individual will produce (or has already produced) intellectual property based on a particular individual's mapped relationships to one or more other individuals in the collaborative environment who have historically produced intellectual property. In some instances, the application(s) 114 may additionally or alternatively include an application (or module) configured to identify one or more projects within the collaborative environment, and/or an application (or module) configured to calculate a probability that a given project will produce (or has already produced) intellectual property based on the individuals in a project who have historically produced intellectual property. Moreover, in some embodiments, the application(s) 114 may additionally or alternatively include an application (or module) configured to identify individuals who would be likely to produce intellectual property together but who do not currently have a working relationship with one another, suggest a relationship between the identified individuals, and/or prompt the identified individuals to connect with one another or join a project together.

Of course, this is not an exhaustive list of the applications 114 that may be stored in the memory 112, and various embodiments and configurations may include additional, fewer, and/or alternative applications, or some combination of the applications described above.

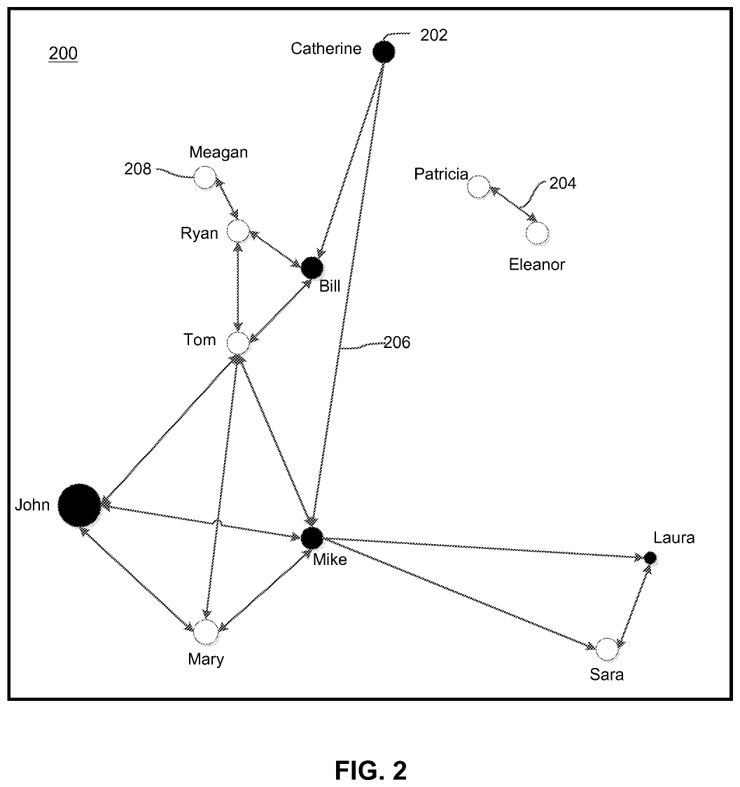

FIG. 2 illustrates an exemplary mapping 200 of relationships between individuals in a collaborative environment. In some instances, mapping 200 may be depicted using a user interface (e.g., user interface 116). In the mapping 200, individuals are represented by points (e.g., points 202 and 208) while relationships between individuals are represented by arrows (e.g., arrows 204 and 206) connecting the points. Two-headed arrows 204 represent bidirectional relationships (e.g., a relationship between teammates/coworkers in a project), while one-headed arrows 206 represent unidirectional relationships (e.g., a supervisory relationship between a manager and an employee). Additionally, the length of each of the arrows may indicate how closely the individuals it connects are related. In some instances, the length of each arrow may indicate how long ago the individuals it connected most recently collaborated. Moreover, a project may be represented by two or more points each connected to one another by arrows (e.g., representing individuals who each have relationships with one another).

The mapping 200 may additionally represent other metrics related to the individuals and their historical production of intellectual property. For example, the color of a point may indicate whether the individual has historically produced intellectual property (e.g., a shaded point 202 may indicate that the individual associated with the point 202 has historically produced intellectual property, while an un-shaded point 208 may indicate that the individual associated with the point 208 has not historically produced intellectual property). As another example, the size of a point may indicate the amount and/or rate of intellectual property the individual has historically produced (e.g., how prolific the individual is). For instance, a larger point may indicate that the individual has historically produced more intellectual property or more frequent intellectual property, while a smaller point may indicate that the individual has historically produced less intellectual property or less frequent intellectual property.

Of course, the mapping 200 shown in FIG. 2 is simply an exemplary mapping. In other embodiments, the relationships between the individuals in the collaborative environment may be mapped in different ways (e.g., using different symbols). Moreover, in other embodiments, additional or alternative information related to the individuals, their relationships, and their historical intellectual property production may be mapped. Furthermore, in some instances, additional or alternative information related to individuals in other collaborative environments, relationships between collaborative environments, etc. may also be mapped.

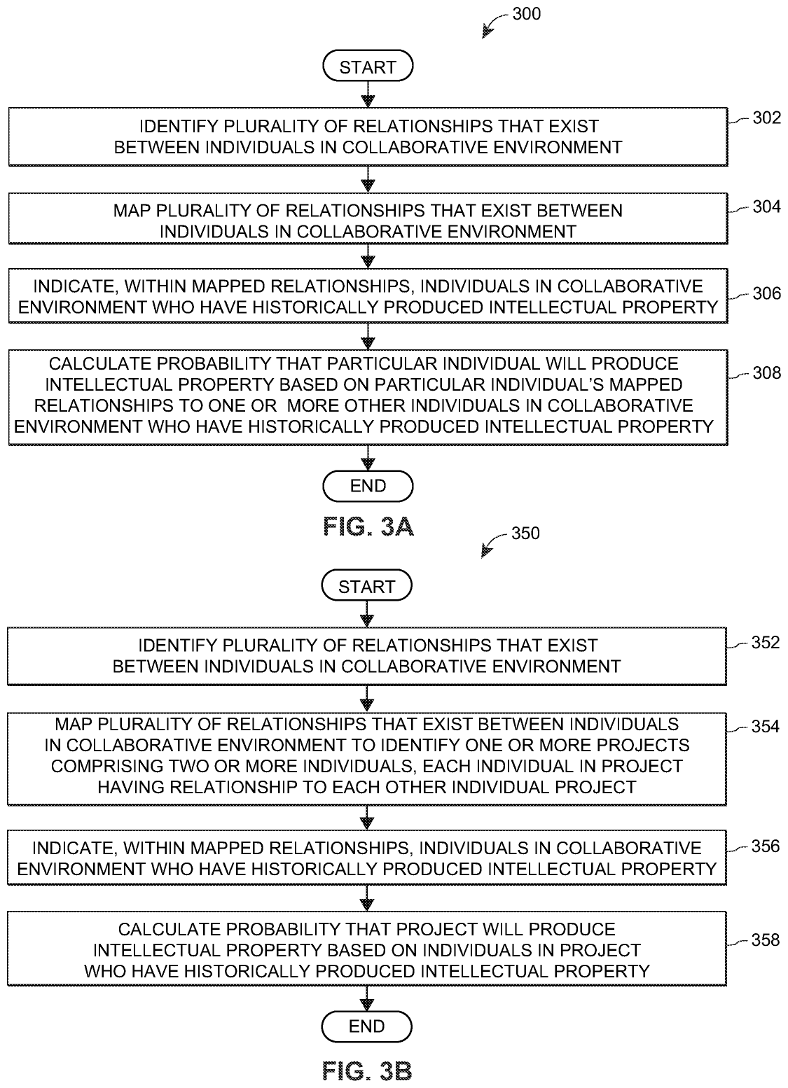

Turning now to FIG. 3A, a flow diagram of an exemplary computer-implemented method 300 for estimating the likelihood that an individual in a collaborative environment will produce (or has already produced) intellectual property is depicted. The method 300 may be implemented by a computer system, such as, e.g., the computer system depicted in FIG. 1.

In the method 300, a plurality of relationships that exist between individuals in a collaborative environment may be identified (block 302), e.g., by one or more processors 110 and/or 118. In some instances, relationships in multiple collaborative environments, relationships between collaborative environments, etc., may be identified as well. For example, the processors 110, 118 may be configured to analyze data associated with the individuals, their relationships, their historical production of intellectual property, etc., e.g., from the database 106 to identify the plurality of relationships that exist between the individuals. The data may include, for instance, the names of all individuals on each project. For example, as shown in FIG. 2, John, Mike, Tom, and Mary are working together on project A. Individuals may also work on multiple projects. For instance, as shown in FIG. 2, Tom might also work on project B with Bill and Ryan, and Ryan might also work on project C with Meagan, and so on. The data may further include projects that each individual worked on in the past. For instance, as shown in FIG. 2, Mike previously worked on project D with Sara and Laura during 2015.

Moreover, the data may include an indication of each individual's level within the project. For example, as shown in FIG. 2, Mike was Sara and Laura's supervisor on project D. Additionally, the data may include an indication of each individual's role, title, and/or level within the collaborative environment. For instance, John may be a senior software developer, while Mike is a junior software developer, and Tom is a junior graphic designer. Furthermore, the data may include an indication of the length of time each individual has been a part of the collaborative environment, e.g., John has been a part of the collaborative environment for ten years, while Mike has been part of the collaborative environment for two years, and Tom has been part of the collaborative environment for three years.

Additionally, the data may include an indication of the intellectual property that each individual has produced in the past, which may include, e.g., the number of patent applications filed by and/or on behalf of each individual, and/or the number of issued patents invented by each individual. For example, Catherine has been listed as an inventor in five patent applications, two of which have issued and three of which are pending, while John has been listed as an inventor of ten patent applications, nine of which have issued and one of which is pending. The data may also include a date or time period when patent applications associated with each individual have been filed. For instance, Catherine filed two patent applications in 2015, one patent application in 2016, and two patent applications in 2017. Additionally, the data may include an indication of co-inventors listed on the patent applications of each individual, and/or an indication of project teams the individual was a part of when the patent applications were filed. For example, Catherine may have filed the first two applications with Bill as a co-inventor, the third with Mike as a co-inventor, and the last two alone.

The data may also include an indication of the field of each project. For instance, project A may be related to developing a user interface, while project B may be related to an advertising campaign, while project C may be related to developing a new chemical compound, etc. In some instances, keywords related to the field of each project may also be indicated in the data.

The plurality of relationships that exist between the individuals in the collaborative environment (and/or between multiple collaborative environments) may be mapped (block 304), e.g., as shown in FIG. 2. In particular, the relationships may be mapped by one or more processors 110 and/or 118, and in some instances the mapped relationships may be graphically depicted using a user interface 116. Moreover, individuals in the collaborative environment who have historically produced intellectual property may be indicated (block 306) within the context of the mapped relationships, by the one or more processors 110 and/or 118, e.g., as shown in FIG. 2. Any of the other data described above associated with the individuals, their relationships, and their historical production of intellectual property, may also be indicated within the context of the mapped relationships.

The probability that a particular individual will produce (or has already produced) intellectual property may be calculated (block 308), e.g., by one or more processors 110 and/or 118, based on the particular individual's mapped relationships to the one or more other individuals in the collaborative environment (and/or to individuals in other collaborative environments) who have produced intellectual property. For example, individuals who work with one another may influence each other's work, and individuals who see others innovating may be inspired to innovate as well. Moreover, when a particular individual works with other individuals who have historically produced intellectual property, this may be an indication that the individual works in a particularly innovative field, and may be more likely to produce intellectual property for that reason.

For example, the probability that a particular individual will produce (or has already produced) intellectual property may be calculated based on a number of mapped relationships that the particular individual has to the one or more other individuals in the collaborative environment who have historically produced intellectual property. E.g., when the particular individual has a greater number of mapped relationships to other individuals in the collaborative environment who have historically produced intellectual property, the particular individual may be more likely to produce intellectual property than other individuals with fewer of such relationships.

As another example, the probability that a particular individual will produce (or has already produced) intellectual property may be calculated based on a frequency with which the one or more other individuals in the collaborative environment have historically produced intellectual property. E.g., when the particular individual has relationships to other individuals who have produced intellectual property more frequently, the particular individual may be more likely to produce intellectual property in general. Moreover, the particular individual may be more likely to produce intellectual property more frequently when related individuals produce intellectual property frequently.

Additionally, the probability that a particular individual will produce (or has already produced) intellectual property may be calculated based on a measure of the closeness of the particular individual's mapped relationships to the one or more other individuals in the collaborative environment who have historically produced intellectual property. For instance, working more closely with someone who produces intellectual property may cause a particular individual to also produce intellectual property.

In some embodiments, the probability that a particular individual will produce (or has already produced) intellectual property may be calculated based on whether the particular individual's mapped relationships to the one or more other individuals in the collaborative environment who have historically produced intellectual property are unidirectional or bidirectional. For example, in some collaborative environments, a particular individual may be more likely to be influenced by a manager or supervisor who has historically produced intellectual property than by someone the individual manages, or by a teammate or coworker. Accordingly, in such environments, the historical intellectual property produced by the supervisor of the particular individual may correlate with the particular individual producing intellectual property. Of course, in other collaborative environments, the correlation may be reversed, e.g., in larger groups a particular individual may be more likely to be influenced by a manager or supervisor, while in smaller groups a particular individual may be more likely to be influenced by a teammate or coworker, or vice-versa.

In some instances, the probability that a particular individual will produce (or has already produced) intellectual property may be calculated based on a frequency at which the particular individual has historically produced intellectual property. E.g., an individual who has produced intellectual property in the past may be more likely to produce intellectual property in the future than an individual who has never produced intellectual property. Moreover, an individual who has frequently produced intellectual property in the past may continue to do so in the future.

As another example, the probability that a particular individual will produce (or has already produced) intellectual property may be calculated based on whether the particular individual has historically produced intellectual property with any of the one or more other individuals in the collaborative environment who have historically produced intellectual property. For example, individuals who have historically produced intellectual property together may be likely to work well together in the future and consequently produce additional intellectual property.

In some instances, a field associated with each mapped relationship may additionally be identified. In those instances, the probability that a particular individual will produce (or has already produced) intellectual property may be calculated based on the fields associated with the particular individual's mapped relationships to the one or more other individuals in the collaborative environment who have historically produced intellectual property. For example, some fields may be more associated with innovation, or may be associated with more frequent innovation than others. Accordingly, individuals associated with such fields may be more likely to produce intellectual property.

Moreover, in some embodiments, an opportunity to disclose potential intellectual property may be provided to the particular individual based on the calculated probability that the particular individual will produce (or has already produced) intellectual property. For example, a meeting may be scheduled between the particular individual and in-house counsel of the collaborative environment, and/or the particular individual may be given an invention disclosure form (IDF). In this way, stakeholders associated with the collaborative environment may ensure that intellectual property produced in the collaborative environment may be captured.

In some instances, the likelihood that a particular project in a collaborative environment will produce (or has already produced) intellectual property may be estimated in addition to, or as an alternative to, estimating the likelihood that a particular individual in the collaborative environment will produce (or has already produced) intellectual property. FIG. 3B depicts a flow diagram of an exemplary computer-implemented method 350 for estimating the likelihood that a project in a collaborative environment will produce (or has already produced) intellectual property. The method 350 may be implemented by a computer system, such as, e.g., the computer system depicted in FIG. 1.

A plurality of relationships that exist between individuals in a collaborative environment may be identified (block 352), e.g., by one or more processors 110 and/or 118. For example, the processors 110, 118 may be configured to analyze data associated with the individuals, their relationships, their historical production of intellectual property, etc., e.g., from the database 106 to identify the plurality of relationships that exist between the individuals.

The plurality of relationships that exist between the individuals in the collaborative environment may be mapped (block 354) to identify one or more projects, e.g., as shown in FIG. 2. Each project may comprise two or more individuals, each of whom have relationships to the other individuals in the project. In particular, the relationships may be mapped by one or more processors 110 and/or 118, and in some instances the mapped relationships may be graphically depicted using a user interface 116. Moreover, individuals in the collaborative environment who have historically produced intellectual property may be indicated (block 356) within the mapped relationships, e.g., as shown in FIG. 2, by the one or more processors 110 and/or 118.

The probability that a given project will produce (or has already produced) intellectual property may be calculated (block 358), e.g., by one or more processors 110 and/or 118, based on the individuals in the project who have historically produced intellectual property. Moreover, in some instances, based on data related to individuals who have historically produced intellectual property, the probability that hypothetical projects will produce intellectual property may also be identified. That is, in some instances, individuals who may be likely to produce intellectual property together but who do not currently have working relationships with one another may comprise a hypothetical project, and may be analyzed in a similar manner as an existing or past project.

For instance, a project (or hypothetical project) that has a greater number of individuals who have historically produced intellectual property (or a higher percentage of individuals who have historically produced intellectual property) may be more likely to produce intellectual property. Additionally or alternatively, the probability that the project will produce (or has already produced) intellectual property may be calculated based on a number of mapped relationships that each individual of the project has to the one or more other individuals in the collaborative environment who have historically produced intellectual property. E.g., a higher number of such mapped relationships may be correlated with a greater probability of the project producing intellectual property.

As another example, the probability that the project will produce (or has already produced) intellectual property may be calculated based on a frequency at which each individual of the project has historically produced intellectual property. For instance, a project that including a greater number of individuals who have historically produced intellectual property frequently (or a higher percentage of individuals who have historically produced intellectual property frequently) may be more likely to produce intellectual property.

As still another example, the probability that the project will produce (or has already produced) intellectual property may be calculated based on a measure of the closeness of each individual of the project's mapped relationships to the one or more other individuals in the collaborative environment who have historically produced intellectual property. E.g., when individuals of the project have close relationships to other individuals within the collaborative environment who have historically produced intellectual property, the project may be more likely to produce intellectual property.

Additionally, in some instances, the probability that the project will produce (or has already produced) intellectual property may be calculated based on whether each individual of the project's mapped relationships to the one or more other individuals in the collaborative environment who have historically produced intellectual property are unidirectional or bidirectional. For example, in some collaborative environments, an individual of a project may be more influenced by a manager who has historically produced intellectual property than by someone the individual manages or by another individual of the project. In such collaborative environments, the probability that the project will produce (or has already produced) intellectual property may be correlated more strongly with whether the manager of the project has historically produced intellectual property. Of course, in other collaborative environments, correlation may be reversed, e.g., in larger groups an individual of a project may be more likely to be influenced by a manager, while in smaller groups an individual of a project may be more likely to be influenced by a teammate, or vice-versa.

Additionally or alternatively, the probability that the project will produce (or has already produced) intellectual property may be calculated based on whether each individual of the project has historically produced intellectual property with any of the one or more other individuals of the project. For example, individuals who have historically produced intellectual property together may be likely to work well together in the future and consequently be more likely produce additional intellectual property in the context of the current project.

Moreover, the probability that the project will produce (or has already produced) intellectual property may additionally be calculated based on one or more fields associated with the project. For example, as discussed above, some fields may be more associated with innovation, or may be associated with more frequent innovation than others. Accordingly, projects associated with those fields may be more likely to produce intellectual property.

Furthermore, in some embodiments, an opportunity to disclose potential intellectual property may be provided to the one or more individuals of the project based on the calculated probability that the project will produce (or has already produced) intellectual property. As discussed above, for example, a meeting may be scheduled between one or more members of the project (or a manager of the project) and in-house counsel of the collaborative environment, and/or the one or more members of the project (or a manager of the project) may be given an invention disclosure form (IDF). In this way, stakeholders associated with the collaborative environment may ensure that intellectual property produced in the collaborative environment may be captured.

Additionally, in the case of a hypothetical project, individuals comprising the hypothetical project may be prompted to connect based on the calculated probability that the hypothetical project be likely to produce intellectual property. That is, two or more individuals who do not currently work together may be prompted to meet one another. In some instances, actual project comprising the individuals of the hypothetical project may be suggested (e.g., to the identified individuals, to their supervisors, to stakeholders, etc.).

Although the foregoing text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within an office environment, or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

1. A computer-implemented method for estimating the likelihood that an individual in a collaborative environment will produce patentable inventions, comprising:
identifying, by one or more processors, a plurality of relationships that exist between individuals in a collaborative environment;
mapping, by the one or more processors, the plurality of relationships that exist between the individuals in the collaborative environment;
graphically depicting, via a user interface, the mapping of the plurality of relationships that exist between the individuals in the collaborative environment, wherein individuals are represented by points and relationships between individuals are represented by arrows connecting the points, wherein lengths of arrows indicate how closely individuals connected by the arrows are related, and sizes of points indicate amounts or rates of intellectual property that the individuals represented by each point have historically produced;
indicating, by the one or more processors, within the graphical depiction of the plurality of mapped relationships, the individuals in the collaborative environment who have historically been listed as inventors in one or more patent applications or issued patents;
calculating, by the one or more processors, based on a particular individual's mapped relationships to one or more other individuals in the collaborative environment who have historically been listed as inventors in one or more patent applications or issued patents, a probability that the particular individual will produce patentable inventions;
scheduling, by the one or more processors, for the particular individual, a meeting to disclose a patentable invention, based on the calculated probability that the particular individual will produce patentable inventions.

2. The computer-implemented method of claim 1, wherein calculating a probability that the particular individual will produce patentable inventions is further based on a number of mapped relationships that the particular individual has to the one or more other individuals in the collaborative environment who have historically been listed as inventors in one or more patent applications or issued patents.

3. The computer-implemented method of claim 1, wherein calculating a probability that the particular individual will produce patentable inventions is further based on a frequency with which the one or more other individuals in the collaborative environment have historically been listed as inventors in one or more patent applications or issued patents.

4. The computer-implemented method of claim 1, wherein calculating a probability that the particular individual will produce patentable inventions is further based on a measure of the closeness of the particular individual's mapped relationships to the one or more other individuals in the collaborative environment who have historically been listed as inventors in one or more patent applications or issued patents.

5. The computer-implemented method of claim 1, wherein calculating a probability that the particular individual will produce patentable inventions is further based on whether the particular individual's mapped relationships to the one or more other individuals in the collaborative environment who have historically been listed as inventors in one or more patent applications or issued patents are unidirectional or bidirectional.

6. The computer-implemented method of claim 5, wherein calculating a probability that the particular individual will produce patentable inventions is further based on a frequency at which the particular individual has historically been listed as an inventor in one or more patent applications or issued patents.

7. The computer-implemented method of claim 5, wherein calculating a probability that the particular individual will produce patentable inventions is further based on whether the particular individual has historically been listed as an inventor in one or more patent applications or issued patents with any of the one or more other individuals in the collaborative environment who have historically been listed as inventors in one or more patent applications or issued patents.

8. The computer-implemented method of claim 1, further comprising:
identifying, by the one or more processors, a field associated with each mapped relationship;
and wherein calculating, by the one or more processors, a probability that the particular individual will produce patentable inventions is additionally based on the fields associated with the particular individual's mapped relationships to the one or more other individuals in the collaborative environment who have historically been listed as inventors in one or more patent applications or issued patents.

9. The computer-implemented method of claim 1, further comprising:
providing, by the one or more processors, to the particular individual, an opportunity to disclose potential patentable inventions, based on the probability that the particular individual will produce patentable inventions.

10. A computer-implemented method for estimating the likelihood that a project in a collaborative environment will produce patentable inventions, comprising:
identifying, by one or more processors, a plurality of relationships that exist between individuals in a collaborative environment;
mapping, by the one or more processors, the plurality of relationships that exist between the individuals in the collaborative environment to identify one or more projects,
wherein each project comprises two or more individuals, each individual in the project having a relationship to each other individual in the project;
graphically depicting, via a user interface, the mapping of the plurality of relationships that exist between the individuals in the collaborative environment, wherein individuals are represented by points and relationships between individuals are represented by arrows connecting the points, wherein lengths of arrows indicate how closely individuals connected by the arrows are related, and sizes of points indicate amounts or rates of intellectual property that the individuals represented by each point have historically produced;
indicating, by the one or more processors, within the graphical depiction of the plurality of mapped relationships, the individuals in the collaborative environment who have historically been listed as inventors in one or more patent applications or issued patents;
calculating, by the one or more processors, based on the individuals in a project who have historically been listed as inventors in one or more patent applications or issued patents, a probability that the project will produce patentable inventions; and
scheduling, by the one or more processors, for the individuals in the project, a meeting to disclose a patentable invention, based on the calculated probability that the project will produce patentable inventions.

11. The computer-implemented method of claim 10, wherein calculating a probability that the project will produce patentable inventions is further based on at least one of:
a number of mapped relationships that each individual of the project has to the one or more other individuals in the collaborative environment who have historically been listed as inventors in one or more patent applications or issued patents;
a frequency at which each individual of the project has historically been listed as an inventor in one or more patent applications or issued patents;
a measure of the closeness of each individual of the project's mapped relationships to the one or more other individuals in the collaborative environment who have historically been listed as inventors in one or more patent applications or issued patents;
whether each individual of the project's mapped relationships to the one or more other individuals in the collaborative environment who have historically been listed as inventors in one or more patent applications or issued patents are unidirectional or bidirectional;
whether each individual of the project has historically been listed as inventors in one or more patent applications or issued patents with any of the one or more other individuals of the project; or
one or more fields associated with the project.

12. A computer system for estimating the likelihood that an individual in a collaborative environment will produce patentable inventions, comprising:
a database configured to store information associated with individuals in a collaborative environment;
a memory configured to store non-transitory computer executable instructions; and
a processor configured to interface with the memory and the database, and configured to execute the non-transitory computer executable instructions to cause the processor to:
identify a plurality of relationships that exist between the individuals in the collaborative environment;
map the plurality of relationships that exist between the individuals in the collaborative environment;
graphically depict, via a user interface, the mapping of the plurality of relationships that exist between the individuals in the collaborative environment, wherein individuals are represented by points and relationships between individuals are represented by arrows connecting the points, wherein lengths of arrows indicate how closely individuals connected by the arrows are related, and sizes of points indicate amounts or rates of intellectual property that the individuals represented by each point have historically produced;
indicate, within the graphical depiction of the plurality of mapped relationships, the individuals in the collaborative environment who have historically been listed as inventors in one or more patent applications or issued patents;
calculate, based on a particular individual's mapped relationships to one or more other individuals in the collaborative environment who have historically been listed as inventors in one or more patent applications or issued patents, a probability that the particular individual will produce patentable inventions; and
schedule, for the particular individual, a meeting to disclose a patentable invention, based on the calculated probability that the particular individual will produce patentable inventions.

13. The computer system of claim 12, wherein the non-transitory computer executable instructions further cause the processor to calculate a probability that the particular individual will produce patentable inventions based on a number of mapped relationships that the particular individual has to the one or more other individuals in the collaborative environment who have historically been listed as inventors in one or more patent applications or issued patents.

14. The computer system of claim 12, wherein the non-transitory computer executable instructions further cause the processor to calculate a probability that the particular individual will produce patentable inventions based on a frequency at which the one or more other individuals in the collaborative environment have historically been listed as inventors in one or more patent applications or issued patents.

15. The computer system of claim 12, wherein the non-transitory computer executable instructions further cause the processor to calculate a probability that the particular individual will produce patentable inventions based on a measure of the closeness of the particular individual's mapped relationships to the one or more other individuals in the collaborative environment who have historically been listed as inventors in one or more patent applications or issued patents.

16. The computer system of claim 12, wherein the non-transitory computer executable instructions further cause the processor to calculate a probability that the particular individual will produce patentable inventions based on whether the particular individual's mapped relationships to the one or more other individuals in the collaborative environment who have historically been listed as inventors in one or more patent applications or issued patents are unidirectional or bidirectional.

17. The computer system of claim 16, wherein the non-transitory computer executable instructions further cause the processor to calculate a probability that the particular individual will produce patentable inventions based on a frequency at which the particular individual has historically been listed as inventors in one or more patent applications or issued patents.

18. The computer system of claim 16, wherein the non-transitory computer executable instructions further cause the processor to calculate a probability that the particular individual will produce patentable inventions based on whether the particular individual has historically been listed as an inventor in one or more patent applications or issued patents with any of the one or more other individuals in the collaborative environment who have historically been listed as inventors in one or more patent applications or issued patents.

19. The computer system of claim 12, wherein the non-transitory computer executable instructions further include instructions that cause the processor to:
identify a field associated with each mapped relationship;
and wherein the non-transitory computer executable instructions further cause the processor to calculate a probability that the particular individual will produce patentable inventions based on the fields associated with the particular individual's mapped relationships to the one or more other individuals in the collaborative environment who have historically been listed as inventors in one or more patent applications or issued patents.

20. The computer system of claim 12, wherein the non-transitory computer executable instructions further include instructions that cause the processor to:
providing, by the one or more processors, to the particular individual, an opportunity to disclose potential patentable inventions, based on the probability that the particular individual will produce patentable inventions.
